(19) United States
(12) Patent Application Publication
(10) Pub. No.: US 2014/0239750 A1
(43) Pub. Date: Aug. 28, 2014

(54) ROTATING ELECTRICAL MACHINE

(71) Applicant: KABUSHIKI KAISHA YASKAWA DENKI, Kitakyushu-shi (JP)

(72) Inventors: Mitsunori NAGAO, Kitakyushu-shi (JP); Takeshi INOUE, Kitakyushu-shi (JP); Toshio NAGAO, Kitakyushu-shi (JP)

(73) Assignee: KABUSHIKI KAISHA YASKAWA DENKI, Kitakyushu-shi (JP)

(21) Appl. No.: 14/268,390

(22) Filed: May 2, 2014

Related U.S. Application Data
(63) Continuation of application No. PCT/JP2011/075902, filed on Nov. 10, 2011.

(51) Int. Cl. H02K 9/00; H02K 5/22

(52) U.S. Cl. CPC H02K 9/005; H02K 5/225
USPC 310/43; 310/68 R; 310/71

(57) ABSTRACT

This disclosure discloses a rotating electrical machine including a rotating electrical machine main body portion including a stator and a rotor, and a winding switching unit configured to switch windings of the stator. The winding switching unit includes a housing including a flow passage through which a coolant is circulated formed inside, an electronic component mounted on a mounting surface of the housing, and a contact surface disposed on the housing and brought into contact with a wiring related member involving an internal wiring including a wiring connecting the windings and the electronic component.

### CROSS-REFERENCE TO RELATED APPLICATION

This is a continuation application PCT/JP2011/075902, filed Nov. 10, 2011, which was published under PCT article 21(2) in English.

### FIELD OF THE INVENTION

A disclosed embodiment relates to a rotating electrical machine

### DESCRIPTION OF THE RELATED ART

A motor integrally including a motor main body portion and a winding switching unit for switching windings of the motor main body portion is known. In this motor, a first cooling water passage is formed inside a motor housing, and a second cooling water passage is formed inside a housing of the winding switching unit.

### SUMMARY OF THE INVENTION

According to one aspect of the disclosure, there is provided a rotating electrical machine including a rotating electrical machine main body portion including a stator and a rotor, and a winding switching unit configured to switch windings of the stator. The winding switching unit includes a housing including a flow passage through which a coolant is circulated formed inside, an electronic component mounted on a mounting surface of the housing, and a contact surface disposed on the housing and brought into contact with a wiring related member involving an internal wiring including a wiring connecting the windings and the electronic component.

### BRIEF DESCRIPTION OF THE DRAWINGS

FIG. 1 is a perspective view illustrating an entire appearance of a state in which an electric motor according to an embodiment is exploded for each major constituent part.

FIG. 2 is an axial side sectional view of the electric motor in an assembled state when seen from an arrow A-A line in FIG. 1.

FIG. 3 is a plan view of a wiring unit when seen from an arrow B-B line section in FIG. 2.

FIG. 4 is a plan view of a switching control unit when seen from an arrow C-C line section in FIG. 2.

FIG. 5 is an axial sectional view of a switching control unit frame when seen from an arrow D-D line section in FIG. 2.

FIG. 6 is a side sectional view of the switching control unit frame when seen from an arrow E-E line section in FIG. 5.

FIG. 7 is a side sectional view corresponding to FIG. 6 of the switching control unit frame including a water-cooling cooling chamber of a variation.

FIG. 8 is a side sectional view corresponding to FIG. 2 of the electric motor when a terminal base for windings is fixed to a water-cooling cooling chamber.

### DESCRIPTION OF THE EMBODIMENTS

An embodiment will be described below by referring to the attached drawings.

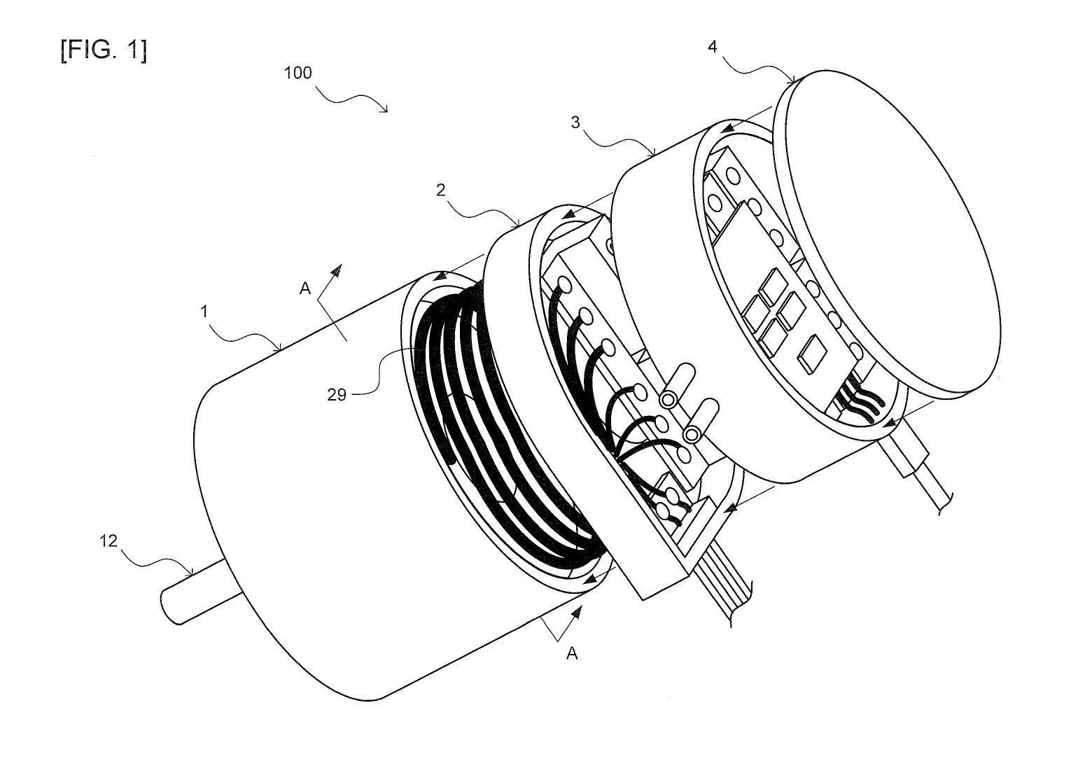

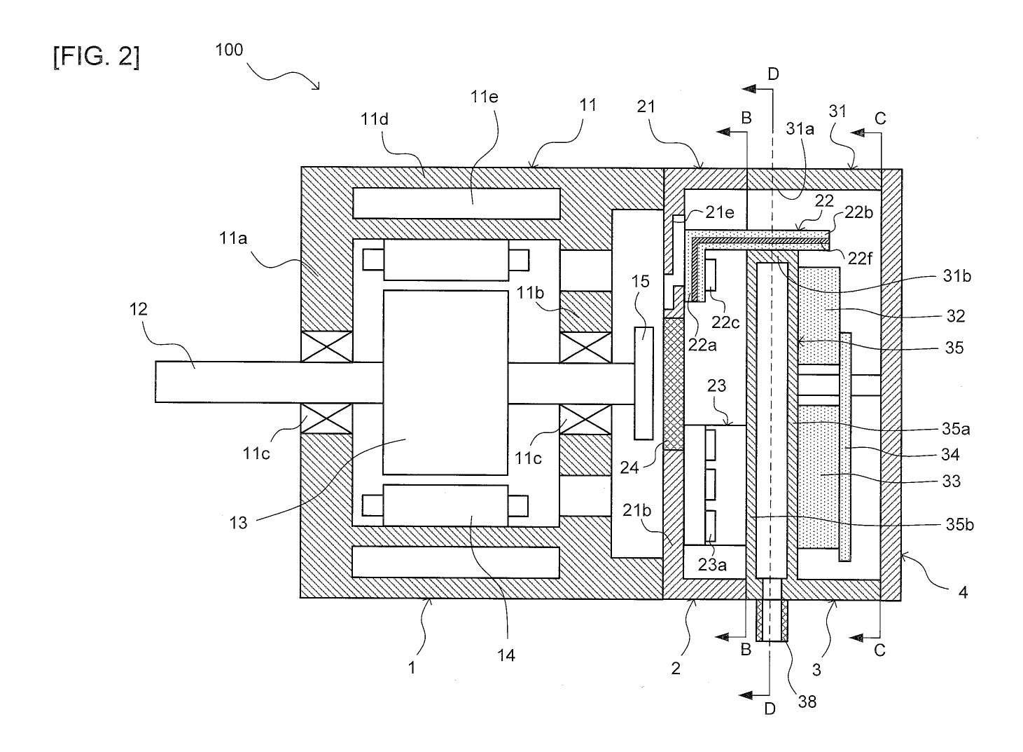

FIG. 1 is a perspective view illustrating an entire appearance of a state in which an electric motor according to an embodiment is exploded for each major constituent part, and FIG. 2 is an axial side sectional view of the electric motor in an assembled state when seen from an arrow A-A line in FIG. 1. The electric motor in the illustrated example is a rotating electric motor applied to a driving motor of an electric automobile, for example. In FIG. 2, wiring of a cable and the like is omitted for avoiding complication of illustration.

In FIGS. 1 and 2, an electric motor 100 has an electric motor main body 1, a wiring unit 2, a switching control unit 3, and a lid portion 4. The electric motor main body 1 has a substantially cylindrical appearance as a whole and has an output shaft 12, which will be described later, protruding on an axial end portion on one side thereof (a lower left side in FIG. 1 and a left side in FIG. 2) and the wiring unit 2 and the switching control unit 3 having the substantially same outer diameters and shapes shorter in the axial direction coaxially stacked and connected on the axial end portion on the side opposite thereto (an upper right side in FIG. 1 and a right side in FIG. 2), respectively. A stacking order is the electric motor main body 1, the wiring unit 2, and the switching control unit 3. Moreover, the lid portion 4 having the same outer diameter is attached to an open end portion of the switching control unit 3, and the entire electric motor 100 is constituted as a substantially cylindrical assembly.

The electric motor main body 1 has an electric motor main body frame 11, the output shaft 12, a rotor 13 in which a permanent magnet is embedded, a stator 14 having windings, and a resolver 15. The electric motor main body frame 11 is generally constituted by having a substantially cylindrical shape and has the axial end portion on the one side (the lower left side in FIG. 1 and the left side in FIG. 2) closed by a closing wall 11a and the axial end portion on the other side (the upper right side in FIG. 1 and the right side in FIG. 2) open. In the illustrated example of this embodiment, the output shaft 12 penetrates the closing wall 11a, and the wiring unit 2 is connected to the axial end portion on the open side. Moreover, a supporting wall 11b is disposed on an axial position close to the open side inside the electric motor main body frame 11, and the output shaft 12 is rotatably supported through a bearing 11c at the respective center positions of the supporting wall 11b and the closing wall 11a. Moreover, inside an outer peripheral side wall 11d of this electric motor main body frame 11, a cooling water passage 11e through which cooling water can flow in a circumferential direction is disposed over the entire periphery. Though not particularly illustrated in detail, this cooling water passage 11e is connected to an external cooling water pump via piping through which the cooling water flows (either of the piping or the cooling water pump is not shown). By allowing the cooling water to flow through the cooling water passage 11e, heat generation of the electric motor main body 1 can be absorbed.

In the example of the electric motor 100 in this embodiment, the rotor 13 in which the permanent magnet is embedded is constituted having a substantially columnar shape, and is coaxially fixed to the output shaft 12 inside the electric motor main body frame 11. Moreover, the stator 14 having windings is constituted having a cylindrical shape and fixed to an inner peripheral surface of the electric motor main body frame 11 in such arrangement of surrounding an outer peripheral side of the rotor 13 in which the permanent magnet is embedded. As described above, the end portion on the one side (the lower left side in FIG. 1 and the left side in FIG. 2) of the output shaft 12 protrudes by penetrating the closing wall 11a of the electric motor main body frame 11, while the end portion on the other side (the upper right side in FIG. 1 and the right side in FIG. 2) is accommodated inside the electric motor main body frame 11. On the end portion on the other side of this output shaft 12, the resolver 15 for detecting a rotation speed or a rotation position of the output shaft 12 is disposed.

The electric motor main body 1 constituted as above is a three-phase AC synchronous motor which can rotationally drive the rotor 13 in which the permanent magnet is embedded and the output shaft 12 by supplying three-phase AC power to the stator 14 having windings and can detect a rotation angle of the rotor 13 by the resolver 15. Though not particularly illustrated, the stator 14 having windings includes two sets of windings each constituting three windings corresponding to each of the three phases in the three-phase AC, respectively, wound in parallel. If the three-phase AC is supplied only to one of these windings, since impedance is low, a sufficient current is allowed to flow even in a high frequency area, which is a suitable state for driving the electric motor 100 at a high speed. Moreover, if the two sets of the windings are connected in series and the three-phase AC is supplied to all of them, since impedance is high, a sufficient voltage can be applied even in a low frequency area, and a larger torque can be generated in the electric motor 100 with respect to the same current, which is a suitable state for a low-speed driving.

The switching control unit 3 is a unit for executing switching control on how the two sets of the windings are connected for the three-phase AC power supplied from the outside, and the wiring unit 2 is a unit accommodating a supply terminal of the three-phase AC power, the switching control unit 3, and a cable for connecting the two sets of the windings of the electric motor main body 1 by optimally routing the cable.

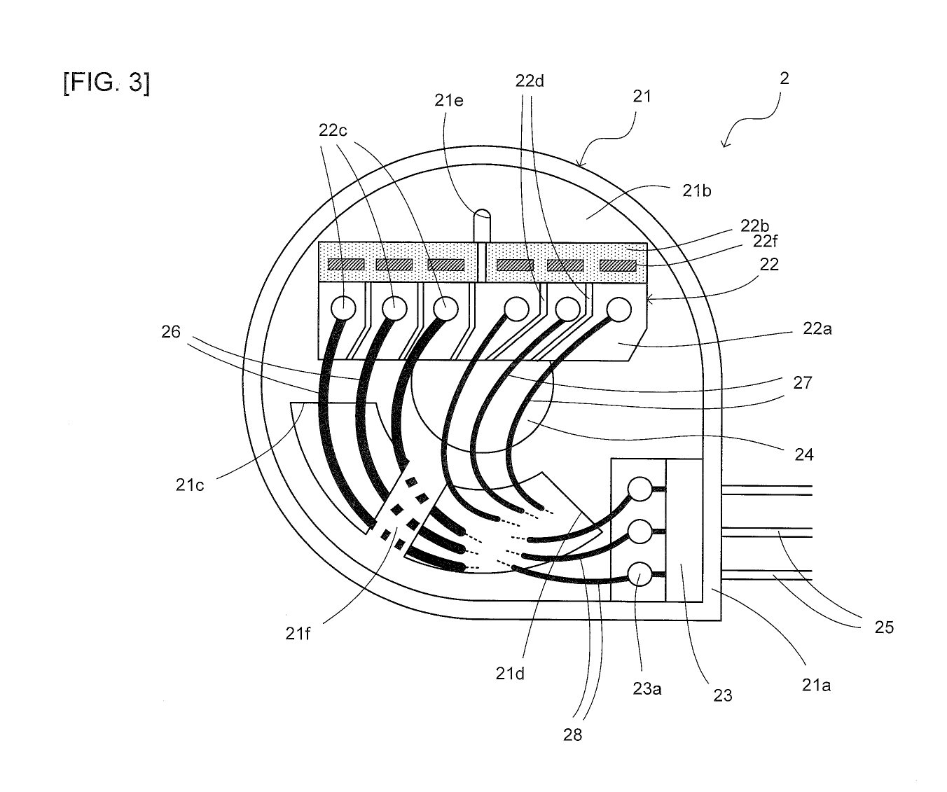

FIG. 3 is a plan view of the wiring unit 2 when seen from an arrow B-B line section in FIG. 2. In the above FIGS. 1 to 3, the wiring unit 2 has a wiring unit frame 21, a terminal base 22 for windings, a terminal base 23 for power supply, and a shield plate 24.

An appearance of the wiring unit frame 21 has a substantially cylindrical shape with the same outer diameter as that of the electric motor main body frame 11 except that it has a corner portion 21a at a position where the terminal base 23 for power supply is arranged on its outer peripheral part. Moreover, this wiring unit frame 21 has a shielding wall 21b on an axial end portion on a side to be connected to the electric motor main body frame 11 (the lower left side in FIG. 1, the left side in FIG. 2, and a depth side in FIG. 3), and an axial end portion on the opposite side (the upper right side in FIG. 1, the right side in FIG. 2, and a front side in FIG. 3) is open. Inside the wiring unit frame 21, the terminal base 22 for windings is fixed to a position close to a shaft center, and the terminal base 23 for power supply at the position of the corner portion 21a on the shielding wall 21b, respectively.

The terminal base 22 for windings as a whole is formed of a molded resin member and integrally includes a base portion 22a directly fixed to the shielding wall 21b and a coupling portion 22b connected to the switching control unit 3. The base portion 22a has a substantially cuboid shape whose height from an installed surface with the shielding wall 21b is relatively low. The coupling portion 22b is arranged having the same length in a longitudinal direction along a side on one side in a width direction (upper sides in FIGS. 2 and 3) of the base portion 22a and has a substantially cuboid shape having such height that its upper end protrudes from the open-side end portion of the wiring unit frame 21. Thus, the terminal base 22 for windings has a shape continuing in a longitudinal direction on a section having a substantially L-shape as illustrated in FIG. 2. On the shielding wall 21b having a substantially circular shape and located on a bottom surface of the wiring unit frame 21, the base portion 22a of the terminal base 22 for windings is shifted from the center of the shielding wall 21b and fixed in arrangement having a side along its longitudinal direction as a chord of the shielding wall 21b. Moreover, the coupling portion 22b is located on a side closer to the outer peripheral side of the shielding wall 21b in the base portion 22a.

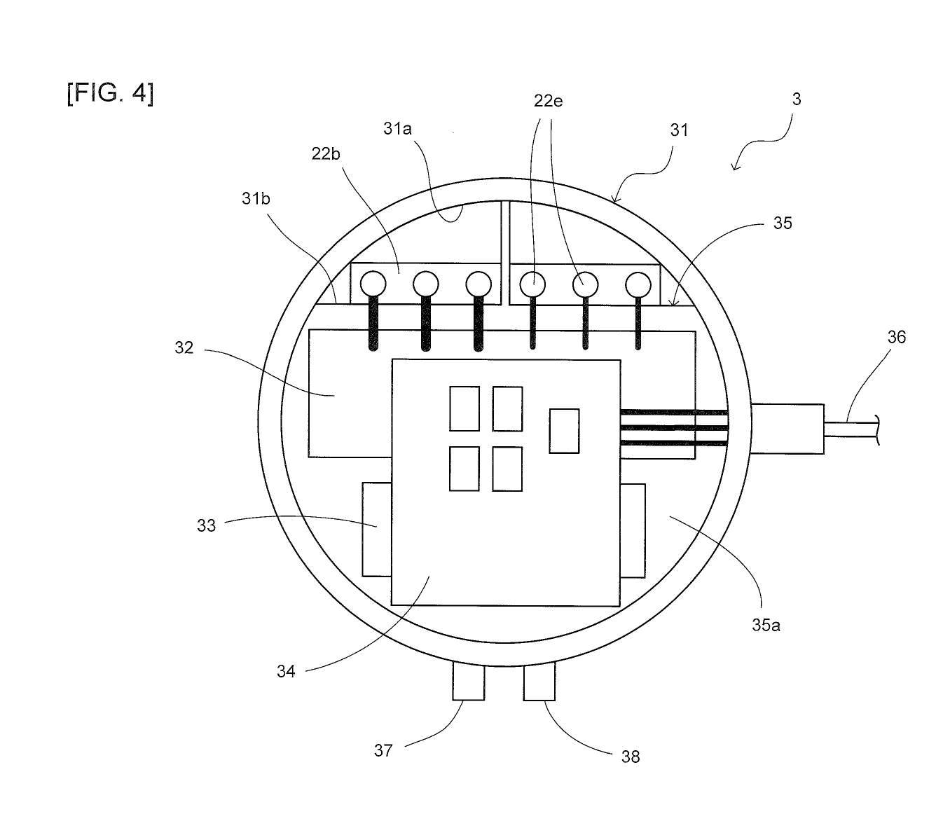

On an upper surface of the base portion 22a other than for connection to the coupling portion 22b, six terminal joining portions 22c are disposed in equal or unequal intervals across its longitudinal direction. A slightly higher dividing wall 22d is disposed between the adjacent two terminal joining portions 22c. Moreover, on a tip end portion of the coupling portion 22b, six connecting portions 22e are disposed in equal or unequal intervals across its longitudinal direction (see FIG. 4 which will be described later). The terminal joining portion 22c and the connecting portion 22e located at the same longitudinal positions are electrically connected to each other through a metallic bus bar 22f disposed inside the base portion 22a and the coupling portion 22b.

The terminal base 23 for power supply has a substantially L-shape section continuing in the longitudinal direction similarly to the terminal base 22 for windings and arranged at the corner portion 21a on the outer peripheral side of the wiring unit frame 21 and fixed to the shielding wall 21b. On this terminal base 23 for power supply, three power supply joining portions 23a are disposed in equal or unequal intervals across its longitudinal direction. These three power supply joining portions 23 a are connected to an external inverter not shown through an external power cable 25.

On a center position of the shielding wall 21b of the wiring unit frame 21, the shield plate 24 having an outer diameter slightly larger than the resolver 15 disposed on the electric motor main body 1 and made of a magnetic body or the like, for example, is disposed. Moreover, in the shielding wall 21b, two insertion holes 21c, 21d are disposed adjacently to each other in appropriate circumferential positions on the outer peripheral side from the shield plate 24. Moreover, in the shielding wall 21b, a communication hole 21e for leading a wiring of the resolver 15 into the wiring unit frame 21 by penetrating the shielding wall 21b is disposed on a position on the outer peripheral side from the terminal base 22 for windings.

Then, in the six terminal joining portions 22c disposed on the base portion 22a of the terminal base 22 for windings, the three of them on the left side in FIG. 3 are joining portions for joining terminals of high-speed cables 26, respectively, and the other three on the right side in FIG. 3 are joining portions for joining terminals of low-speed cables 27, respectively. The coupling portion 22b is divided into two parts in the longitudinal direction in correspondence with each of the high-speed cables 26 and the low-speed cables 27. The three power supply joining portions 23a disposed on the terminal base 23 are joining portions for joining terminals of power cables 28, respectively. Each of the joining portions joins the terminal of each of the cables by fastening of a bolt and the like. The high-speed cables 26, the low-speed cables 27, and the power cables 28 are wired in three each, and each of the three corresponds to each of the phases U, V, and W of the three-phase AC.

The power cables 28 are cables through which the three-phase AC current for driving supplied from the external inverter, not shown, flows. The high-speed cables 26 are cables to be connected at switching to high-speed driving to the two sets of windings disposed inside the above electric motor main body 1, and since a relatively large current flows depending on a switched state of connection, a thick cable is used. The low-speed cables 27 are cables to be connected at switching to low-speed driving to the two sets of windings disposed inside the above electric motor main body 1 and since a current equal to or lower than that of the power cables 28 flows in any switched state of connection, a cable with the same thickness as that of the power cables 28 is used.

The three high-speed cables 26 are inserted through the insertion hole 21c at a position closest to the terminal base 22 for windings and inserted into the electric motor main body 1. The three low-speed cables 27 pass through the other insertion hole 21d and are inserted into the electric motor main body 1. The six cables in total, that is, the high-speed cables 26 and the low-speed cables 27 inserted into the electric motor main body 1 are accommodated in a state wound in several turns in the same winding direction on the inner peripheral side of the electric motor main body frame 11, respectively, and the respective end portions protruding from the wound portion 29 are connected to the two sets of windings (the entire wiring including this wound portion 29 is omitted in FIG. 2).

A winding path of the wound portion 29 of the cables in this electric motor main body 1 is a circular path drawn in a counterclockwise direction along an inner surface of the outer peripheral side wall 11d of the electric motor main body frame 11 having an outer diameter equal to the wiring unit frame 21 when seen from a section in FIG. 3 (not particularly shown). With respect to this circular path, the high-speed cables 26 with the arrangement illustrated in FIG. 3 can be routed so as to enter in a wiring path with a relatively small curvature (large radius of curvature). Moreover, with respect to the same circular path, the low-speed cables 27 with the arrangement illustrated in FIG. 3 are routed so as to enter in a wiring path with a relatively large curvature (small radius of curvature).

Here, the dividing wall 22d between the adjacent two terminal joining portions 22c on the upper surface of the base portion 22a is disposed in a direction along the wiring path of the cables in the vicinity. Considering an outlet position between the dividing walls 22d, connection can be regarded such that the thickest three high-speed cables 26 are wired on an outermost peripheral side in a radial direction of the terminal base 22 for windings and the thinnest low-speed cables 27 are wired at the substantially center positions in the radial direction of the terminal base 22 for windings, respectively. The radial direction, here, means a radial direction in the wiring unit frame 21 having a substantially cylindrical shape. Moreover, in the wiring path of this illustrated example, the three high-speed cables 26 and the three low-speed cables 27 are arranged so as to abut to each other.

FIG. 4 is a plan view of the switching control unit 3 when seen from an arrow C-C line section in the above FIG. 2. In the above FIGS. 1, 2, and 4, the switching control unit 3 has a switching control unit frame 31, a diode module 32, an IGBT module 33, and a control circuit board 34.

An appearance of the switching control unit frame 31 has a substantially cylindrical shape with the same outer diameter as the electric motor main body frame 11. Moreover, this switching control unit frame 31 has a water-cooling cooling chamber 35 on an axial end portion on a side to be connected to the wiring unit frame 21 (the lower left side in FIG. 1, the left side in FIG. 2, and the depth side in FIG. 4) and an axial end portion on the other side (the upper right side in FIG. 1, the right side in FIG. 2, and the front side in FIG. 4) open. The water-cooling cooling chamber 35 is disposed so as to open toward the wiring unit 2 in a part (an upper part in FIGS. 2 and 4) in the circumferential direction of the switching control unit frame 31 and to be shielded on the whole surface other than that. When the water-cooling cooling chamber 35 is connected with the wiring unit 2, the coupling portion 22b of the terminal base 22 for windings penetrates the open part (hereinafter referred to as an open port 31a) on which this water-cooling cooling chamber 35 is not disposed and is inserted into the switching control unit frame 31. A structure of the water-cooling cooling chamber 35 will be described later in detail.

Inside the switching control unit frame 31, the diode module 32 is fixed to an upper surface wall 35a at a position on a side close to the open port 31a and the IGBT module 33 at a position on a side far from the open port 31a (a wall surface on the right side in FIG. 2 and the wall surface on the front side in FIG. 4) of the water-cooling cooling chamber 35, respectively. The control circuit board 34 is fixed in arrangement stacking on an upper side (the right side in FIG. 2 and the front side in FIG. 4) of the diode module 32 and the IGBT module 33 and is connected to an external switching controller, not shown, via an external control cable 36. Here, for convenience of explanation, a side of the lid portion 4 is assumed to be the upper side and a side of the electric motor main body 1 to be the lower side. The diode module 32 is connected from the six connecting portions 22e at the tip end of the coupling portions 22b inserted into the switching control unit 3 from the wiring unit 2 via respective appropriate wirings. Moreover, the IGBT module 33 is connected to the diode module 32 and the control circuit board 34 via respective appropriate wirings (these wirings are not shown). Among them, since a large current flows through the connecting portion 22b, the diode module 32, and the IGBT module 33 via the high-speed cable 26 and the low-speed cable 27, high-temperature heat is generated. Thus, these connecting portion 22b, the diode module 32, and the IGBT module 33 need to be brought into contact with a member constituting the water-cooling cooling chamber 35 disposed on the switching control unit frame 31 so as to absorb heat.

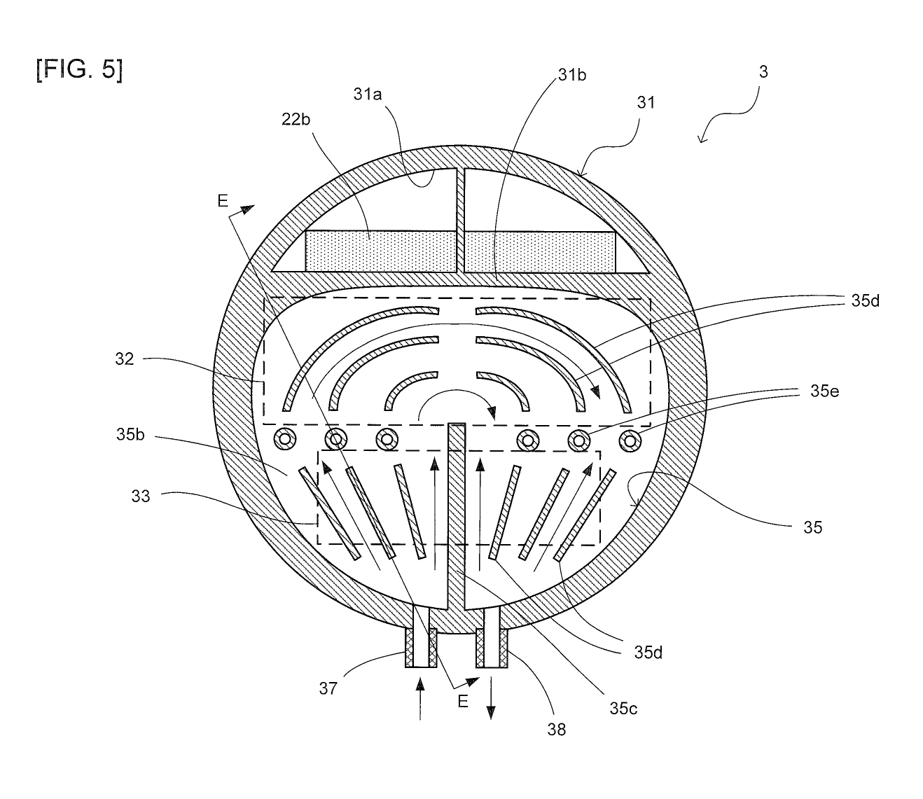

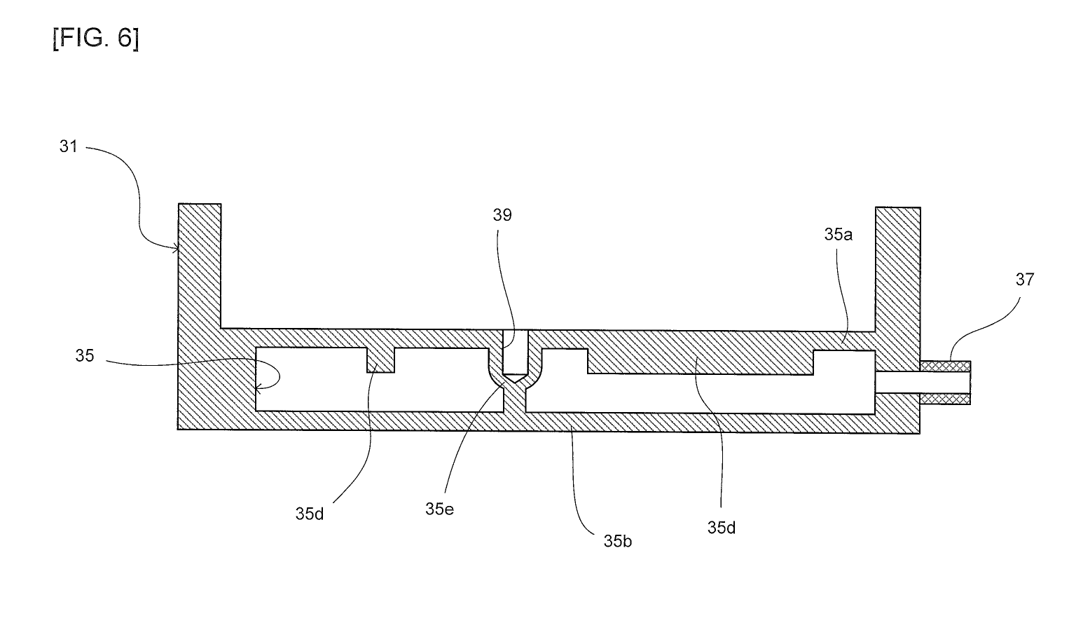

FIG. 5 is an axial sectional view of the switching control unit frame 31 when seen from an arrow D-D line section in FIG. 2, and FIG. 6 is a side sectional view of the switching control unit frame 31 when seen from an arrow E-E line section in FIG. 5. That is, FIGS. 5 and 6 illustrate an axial section and a side section mainly of the water-cooling cooling chamber 35, respectively. In these FIGS. 5 and 6, the water-cooling cooling chamber 35 is constituted by a sealed space surrounded on its sides by a portion on the outer peripheral side surface of the switching control unit frame 31 except a peripheral part of the open port 31a to the wiring unit 2 side and an inner wall portion 3 lb partitioning the open port 31a and further sandwiched by a lower surface wall 35b located on the wiring unit 2 side and the upper surface wall 35a on a side opposite in the axial direction. In the example of this embodiment, the respective inner surfaces of the lower surface wall 35b and the upper surface wall 35a are arranged so as to face each other in parallel.

Moreover, inside the water-cooling cooling chamber 35, a partition wall portion 35c extending over an outer peripheral side wall on a side (a lower side in FIGS. 2 and 5) opposite to the open port 31a from its substantially center position and connecting the lower surface wall 35b and the upper surface wall 35a is disposed, and thus, the entirety of the water-cooling cooling chamber 35 seen on a plan view of FIG. 5 has a substantial U-shape (vertically inverted in FIG. 5). The outer peripheral side walls at both end positions of this substantial U-shape, that is, at two positions sandwiching the partition wall portion 35c on the side opposite to the open port 31a are opened, respectively, and nozzles 37 and 38 are disposed with communication, respectively. In the example of this embodiment, the nozzle 37 on the left side in FIG. 5 functions as the supply port nozzle 37 which supplies cooling water into the water-cooling cooling chamber 35, while the nozzle 38 on the right side in FIG. 5 functions as the discharge port nozzle 38 which discharges the cooling water from the inside of the water-cooling cooling chamber 35. The supply port nozzle 37 and the discharge port nozzle 38 are connected to an external cooling water pump via a piping through which the cooling water is made to flow (both piping and the cooling water pump are not shown).

Inside this substantially U-shaped water-cooling cooling chamber 35, the cooling water flows in a direction from the supply port nozzle 37 toward the discharge port nozzle 38, and a shape of the water-cooling cooling chamber 35 seen on the plan view of FIG. 5 is formed such that a side of the open port 31a (that is, a bent side of the substantial U-shape) has a flow passage width larger than that of a side on which the supply port nozzle 37 and the discharge port nozzle 38 are disposed (that is, the both end sides of the substantial U-shape). That is, it is formed such that the flow passage width expands from the side of the two nozzles 37 and 38 toward a flow passage depth side. Particularly in an area partitioned by the partition wall portion 35c, it is formed such that the flow passage width expands from the side of the nozzles 37 and 38 toward the open port 31a side.

Moreover, inside the water-cooling cooling chamber 35, a plurality of rectifying fins 35d is disposed on the upper surface wall 35a of the wiring unit 2 side. These rectifying fins 35d are wall portions protruding to such a degree that does not reach the lower surface wall 35b from the upper surface wall 35a and disposed in the number of four along the flowing direction of the cooling water, respectively, in each area of the path through which the cooling water flows. As described above, particularly in the area partitioned by the partition wall portion 35c, it is formed such that the flow passage width expands from the side of the nozzles 37 and 38 toward the open port 31a side, and thus, each of the rectifying fins 35d disposed in the area is arranged substantially radially. In the other areas, the four rectifying fins 35d are arranged substantially in parallel along the flowing direction of the cooling water.

Moreover, inside the water-cooling cooling chamber 35, attaching portions 35e each having a screw hole 39 for bringing the diode module 32 and the IGBT module 33 into contact with and fixing them to the upper surface wall 35a therein are disposed. Each of the rectifying fins 35d is disposed in arrangement not interfering with these attaching portions 35e. Each of the attaching portions 35e is disposed from the upper surface wall 35a to the lower surface wall 35b so as to connect to the both. In this way, the diode module 32 and the IGBT module 33 are fixed to each of the attaching portions 35e via a screw screwed with each of the screw holes 39 and in contact over a wide range with the upper surface wall 35a of the water-cooling cooling chamber 35. As a result, even if a large current flows through the diode module 32 and the IGBT module 33 and heat is generated, the heat can be absorbed by the water-cooling cooling chamber 35. Moreover, even if the same water-cooling cooling chamber 35, a flow velocity of the cooling water is faster in the area on the side of the nozzles 37 and 38 where the flow passage width is small (the area on the lower sides in FIGS. 2 and 5) than in the area on the open port 31 a side where the flow passage width is large (the area on the upper sides in FIGS. 2 and 5), and cooling efficiency is higher. Thus, as illustrated, the IGBT module 33 in which a heating temperature is relatively high is arranged in the area on the side of the nozzles 37 and 38, while the diode module 32 in which a heating temperature is relatively low is arranged in the area on the open port 31a side.

Moreover, as illustrated in FIGS. 2 and 5, the coupling portion 22b of the terminal base 22 for windings penetrating the open port 31 a from the wiring unit 2 and inserted into the switching control unit 3 brings a flat surface on its side portion into contact with the inner wall portion 31b on the open port 31a side of the water-cooling cooling chamber 35. As a result, even if a large current flows through the bus bar 22f disposed inside the coupling portion 22b and the entire coupling portion 22b generates heat, the heat can be absorbed by the water-cooling cooling chamber 35. Moreover, since the terminal base 23 for power supply is also a member generating heat when a current flows, by bringing its tip end portion having a substantially L-shaped section into contact with the lower surface wall 35b of the water-cooling cooling chamber 35 as illustrated in FIG. 2, the heat can be absorbed. Moreover, though not particularly illustrated, the wiring connected to the resolver 15 disposed inside the electric motor main body 1 is wired through the communication hole 21 e of the wiring unit frame 21 and the open port 31 a of the switching control unit frame 31 and is connected to the control circuit board 34.

Looking at the entire electric motor 100 configured as above, the electric motor main body 1, the wiring unit 2, the switching control unit 3, and the lid portion 4 are stacked in this order and coupled as described above. Among them, the electric motor main body 1 including the stator 14 having windings therein has the largest heat generation amount, and then, the switching control unit 3 including the diode module 32 and the IGBT module 33 therein have the second largest heat generation amount. Though the wiring unit 2 has the terminal bases 22 and 23 and the cables 26, 27, and 28 disposed therein generating heat by flowing a large current, the heat generation amount by the unit is considerably lower than the electric motor main body 1 and the switching control unit 3. As a result, the wiring unit 2 functions as an insulating chamber which shuts off transfer of the heat from the electric motor main body 1 to the switching control unit 3.

In the above, the output shaft 12 corresponds to an example of the shaft described in each claim, the electric motor main body 1 corresponds to an example of the rotating electrical machine main body portion described in each claim, the switching control unit 3 corresponds to an example of the winding switching unit described in each claim, the cooling water (not particularly shown) corresponds to an example of the coolant described in each claim, the water-cooling cooling chamber 35 corresponds to an example of the flow passage described in each claim, the switching control unit frame 31 corresponds to an example of the housing described in each claim, the surface on the upper side (the right side in FIG. 2 and the upper side in FIG. 6) of the upper surface wall 35a corresponds to an example of the mounting surface described in each claim, the diode module 32 and the IGBT module 33 correspond to an example of electronic components described in each claim, the high-speed cable 26, the low-speed cable 27, and the power cable 28 correspond to an example of the plurality of internal wirings described in each claim, a molded resin member of the terminal base 22 for windings and the terminal base 23 for power supply and the bus bar 22f, the high-speed cable 26, the low-speed cable 27, and the power cable 28 correspond to an example of the wiring-related members described in each claim, the surface on the lower side (the left side in FIG. 2 and the lower side in FIG. 6) of the lower surface wall 35b corresponds to an example of the contact surface and the opposite mounting surface described in each claim, the inner wall portion 31b corresponds to an example of the contact surface and the side surface described in each claim, and the entire electric motor 100 corresponds to an example of the rotating electrical machine described in each claim. Moreover, the terminal base 22 for windings corresponds to an example of the terminal base and the first terminal base described in each claim, the external power cable 25 corresponds to an example of the power cable described in each claim, and the terminal base 23 for power supply corresponds to an example of the terminal base and the second terminal base described in each claim.

The structure that bringing the terminal base 22 for windings into contact with the inner wall portion 31b of the switching control unit frame 31 and bringing the terminal base 23 for power supply into contact with the lower surface portion 35b of the switching control unit frame 31 corresponds to an example of mean for cooling an internal wiring including a wiring connecting the windings and the electronic component with a compact structure described in the claims.

As described above, according to the electric motor 100 of this embodiment, the switching control unit 3 has the switching control unit frame 31 having the water-cooling cooling chamber 35 through which the cooling water is circulated formed inside, and on the upper surface wall 35a of this switching control unit frame 31, the diode module 32 and the IGBT module 33 which generate heat are mounted. As a result, the diode module 32 and the IGBT module 33 are cooled by the cooling water circulating through the water-cooling cooling chamber 35.

On the other hand, in the switching control unit frame 31, the inner wall portion 31b and the lower surface wall 35b in contact with the terminal base 22 for windings and the terminal base 23 for power supply involving the high-speed cable 26, the low-speed cable 27, and the power cable 28 which connect the windings of the stator 14 and the diode module 32 and the IGBT module 33 of the switching control unit 3 to each other are disposed. The terminal base 22 for windings and the terminal base 23 for power supply generate heat when an electric current flows. In this embodiment, by bringing the terminal base 22 for windings into contact with the inner wall portion 31b of the switching control unit frame 31 and by bringing the terminal base 23 for power supply into contact with the lower surface portion 35b of the switching control unit frame 31, heat exchange can be performed with the cooling water, respectively, for cooling the same. Moreover, since the terminal base 22 for windings and the terminal base 23 for power supply can be cooled by using the cooling structure of the switching control unit 3 as above, there is no need to separately dispose the cooling structure, and the size of the electric motor 100 is not increased, either. Therefore, the high-speed cable 26, the low-speed cable 27, and the power cable 28 which are the internal wirings can be sufficiently cooled with a compact structure.

Moreover, according to this embodiment, the terminal base 22 for windings is brought into contact with the inner wall portion 31b for cooling the same, and the high-speed cable 26 and the low-speed cable 27 connected via the terminal base 22 for windings are cooled. Moreover, the terminal base 23 for power supply is brought into contact with the lower surface wall 35b for cooling the same, and the power cable 28 connected through the terminal base 23 for power supply is cooled. As described above, by having the structure in which the terminal base 22 for windings and the terminal base 23 for power supply are brought into contact, a contact area can be increased as compared with the case in which the cable itself is brought into contact with the inner wall portion 31b and the lower surface wall 35b for cooling the same, and cooling efficiency can be improved. Moreover, if the terminal base 22 for windings and the terminal base 23 for power supply are fixed to the inner wall portion 31b and the lower surface wall 35b, they are brought into close contact, and the cooling efficiency can be further improved.

Moreover, according to this embodiment, by making the upper surface wall 35a on which the diode module 32 and the IGBT module 33 are mounted and the lower surface wall 35b arranged on the opposite side with the water-cooling cooling chamber 35 sandwiched between them into a contact surface to be brought into contact with the heat generating member, a wide contact surface having an area substantially equal to the upper surface wall 35a can be ensured. Moreover, by making the side surface such as the inner wall portion 31b surrounding the periphery of the upper surface wall 35a into the contact surface, a wider contact surface can be ensured, and by having the contact surface at an angle different from that of the lower surface wall 35b, freedom in a contact mode between the contact surface and each of the terminal bases 22 and 23 can be improved. Therefore, cooling performances of the switching control unit 3 can be improved.

Moreover, according to this embodiment, by bringing the terminal base 22 for windings into contact with the inner wall portion 31b for cooling the same, the high-speed cable 26 and the low-speed cable 27 which connect the windings of the stator 14 and the diode module 32 and the IGBT module 33 of the switching control unit 3 through the terminal base 22 for windings can be efficiently cooled.

Moreover, according to this embodiment, since the terminal base 22 for windings has the bus bar 22f and the molded resin member, and by contact between the flat surface formed on the molded resin member and the inner wall portion 31b, the bus bar 22f is cooled. Since the bus bar 22f has a sectional area larger than that of the windings in general, by converting the end portion of the windings to the bus bar 22f and then, by performing heat exchange, a heat conducting area can be increased, and the cooling efficiency can be improved. Moreover, by forming the flat surface on the molded resin member, close contact with the side surface is enhanced, and the cooling efficiency can be further improved.

Moreover, according to this embodiment, by bringing the terminal base 23 for power supply into contact with the lower surface wall 35b for cooling the same, the power cable 28 which connects the windings of the stator 14 and the external power cable 25 through the terminal base 23 for power supply can be efficiently cooled.

In the above embodiment, the terminal bases 22 for windings are disposed by being gathered into one group, but the present disclosure is not limited to that. For example, two terminal bases 22 for windings individually corresponding to each of the high-speed cable 26 and the low-speed cable 27 may be disposed or may be divided into three parts or more and disposed. Moreover, the three high-speed cables 26 are the thickest, and the three low-speed cables 27 and the three cables 28 for power supply are cables having the same thickness, but the thickness does not have to be limited to two types as above. For example, one of the high-speed cables 26 may be the thickest and the other high-speed cables 26 may be thinner than that or any one of the low-speed cables 27 may be made thicker than the thinner high-speed cables. That is, the number of types of cable thickness may be three or more. In this case, the wiring path of the thinnest cable does not have to be located at the center position in the radial direction. That is, it is only necessary that the wiring path of the thickest cable is located at an outermost peripheral position in the radial direction in principle, and a cable having a medium thickness other than them may be located at the center position in the radial direction.

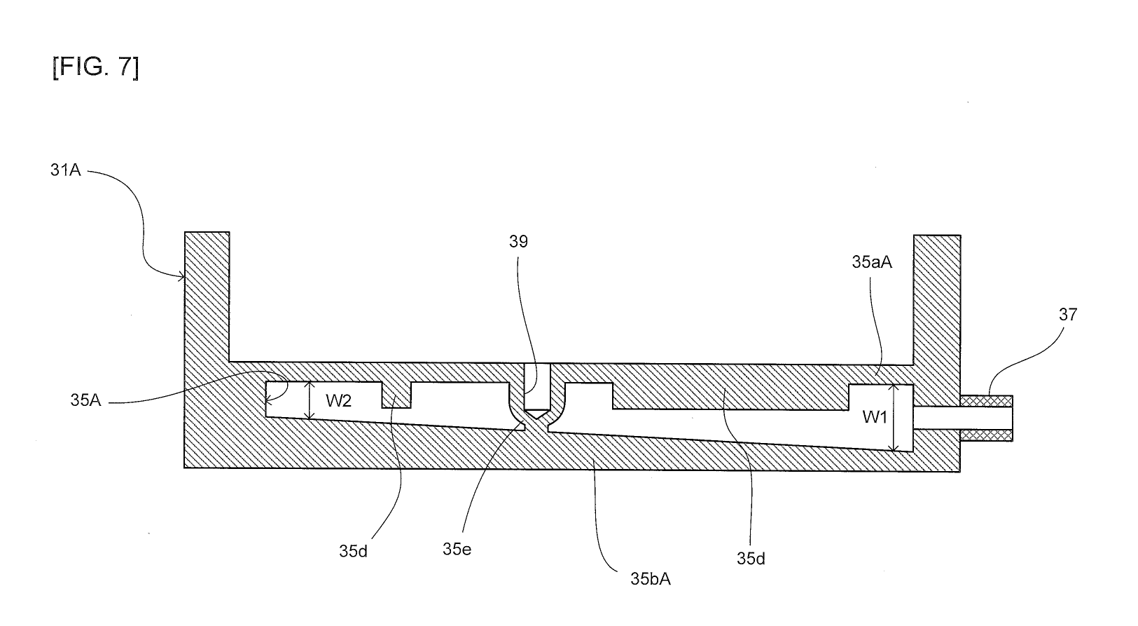

In the water-cooling cooling chamber 35 disposed in the switching control unit frame 31, the lower surface wall 35b and the upper surface wall 35a are arranged in the manner that the respective inner surfaces face each other in parallel in the above embodiment, but the present disclosure is not limited to that. For example, as illustrated in FIG. 7 corresponding to FIG. 6, regarding the flow passage width when seen from the side surface direction, a lower surface wall 35bA and an upper surface wall 35aA may be arranged with the respective inner surfaces inclined to each other in the manner that a flow passage width W2 on the open port 31a side becomes smaller than a flow passage width W1 on the side of the nozzles 37 and 38. That is, the shape of flow passage may be formed in the manner that its depth becomes shallower from the side of the nozzles 37 and 38 toward the flow passage depth side. By forming the flow passage shape as above, a flow passage sectional area can be kept substantially constant while the flow passage width when seen from a plane direction in FIG. 5 is expanded from the side of the nozzles 37 and 38 toward the flow passage depth side. As a result, since a flow velocity of the cooling water can be kept substantially constant, an area of a cooling surface can be increased without lowering cooling efficiency. As a result, the cooling performances can be further improved.

Moreover, the water-cooling cooling chamber 35 having the above configuration can be applied also to those other than the above switching control unit 3 and the electric motor 100 and can be applied to an inverter which similarly generates heat at a high temperature, for example. Moreover, the rectifying fin 35d is disposed on a wall portion protruding to such a degree that does not reach the lower surface wall 35b from the upper surface wall 35a but this is not limiting. For example, it may protrude from the lower surface wall 35b or may protrude from both the lower surface wall 35b and the upper surface wall 35a with a clearance disposed therebetween or in the manner that they are connected.

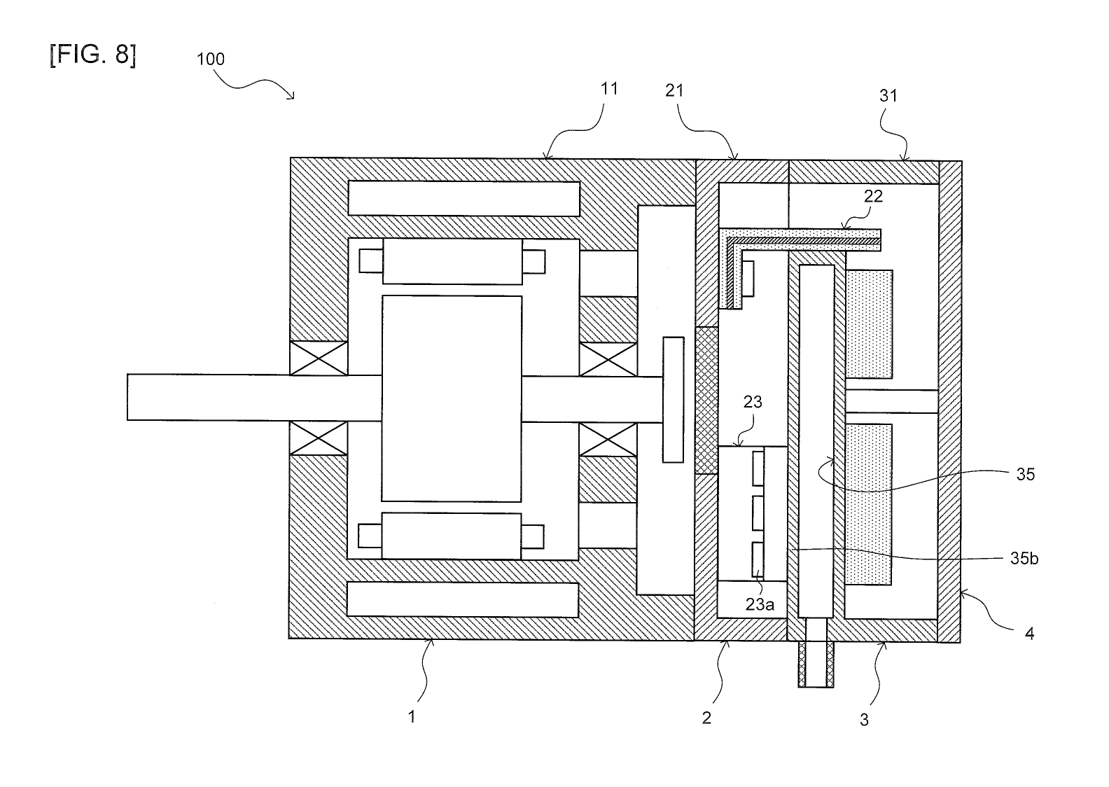

As illustrated in FIG. 8 corresponding to FIG. 2, cooling efficiency may be further improved by bringing a bottom side portion having a substantially L-shaped section in the terminal base 23 for power supply into contact with the lower surface wall 35b of the water-cooling cooling chamber 35 and fixing the terminal base 23 for power supply itself to the water-cooling cooling chamber 35. Moreover, among the members on the wiring unit 2 side, only the flat surfaces of the resin parts of the terminal bases 22 and 23 are brought into contact with the inner wall portion 31b and the lower surface wall 35b of the water-cooling cooling chamber 35, but this is not limiting. For example, each of the cables 26, 27, and 28 may be wired so as to be in contact with any one of the wall portions constituting the water-cooling cooling chamber 35. Alternatively, the metallic bus bar 22f inside each of the terminal bases 22 and 23 may be exposed to the outside and brought into direct contact with any one of the wall portions constituting the water-cooling cooling chamber 35. In this case, a configuration giving consideration to insulation between each of the bus bars is required.

The electric motor main body frame 11 and the wiring unit frame 21 are constituted as separate bodies, but this is not limiting. For example, though not particularly shown, the electric motor main body frame 11 and the wiring unit frame 21 may be integrally formed. In this case, in order to facilitate an access to the inside of the electric motor main body frame 11, the closing wall 11 a needs to be constituted as a separate body so as to be formed detachably. Alternatively, the wiring unit frame 21 and the switching control unit frame 31 may be integrally formed. Moreover, the electric motor main body 1 and the wiring unit 2 do not necessarily have to be coupled adjacently, and a brake unit or the like coupled with the output shaft 12 may be arranged between them and coupled with them, for example. Moreover, in the electric motor main body 1, the wiring unit 2 and the switching control unit 3 are arranged and coupled on the axial end portion on the side opposite to the side where the output shaft 12 is protruded, but this is not limiting. For example, the wiring unit 2 and the switching control unit 3 may be arranged and coupled on the axial end portion on the side where the output shaft 12 of the electric motor main body 1 is protruded. In this case, it should be configured such that the output shaft 12 penetrates at the center position of wiring unit 2 and the switching control unit 3.

Moreover, in the above embodiment, the supporting wall 11b as an opposite load-side bracket and the wiring unit 2 are made separately, but it may be so configured that the wiring unit frame 21 of the wiring unit 2 includes the supporting wall and supports the bearing 11c, for example. In other words, it may be so configured that the wiring unit 2 is disposed on the opposite load-side bracket. As a result, further size reduction of the electric motor 100 can be realized.

Moreover, in the above embodiment, the case in which the rotating electrical machine is an electric motor is explained as an example, but this is not limiting, and the present disclosure can be applied also to a case in which the rotating electrical machine is a generator.

Moreover, other than those described above, the embodiment and the method by each variation may be combined as appropriate for use.

Though not particularly exemplified, the present disclosure is put into practice with various changes added within a range not departing from its gist.

What is claimed is:

1. A rotating electrical machine comprising:
a rotating electrical machine main body portion including a stator and a rotor; and
a winding switching unit configured to switch windings of the stator,
the winding switching unit includes:
a housing including a flow passage through which a coolant is circulated formed inside;
an electronic component mounted on a mounting surface of the housing; and
a contact surface disposed on the housing and brought into contact with a wiring related member involving an internal wiring including a wiring connecting the windings and the electronic component.

2. The rotating electrical machine according to claim 1, wherein
the wiring related member is a terminal base to which the internal wiring is connected; and
the contact surface is brought into contact with the terminal base.

3. The rotating electrical machine according to claim 1, wherein
the contact surface is at least one of a side surface surrounding a periphery of the mounting surface and an opposite mounting surface arranged on a side opposite to the mounting surface with the flow passage sandwiched therebetween.

4. The rotating electrical machine according to claim 2, wherein
the contact surface is at least one of a side surface surrounding a periphery of the mounting surface and an opposite mounting surface arranged on a side opposite to the mounting surface with the flow passage sandwiched therebetween.

5. The rotating electrical machine according to claim 3, wherein
the side surface is brought into contact with a first terminal base configured to connect an end portion of the windings to the electronic component electrically.

6. The rotating electrical machine according to claim 4, wherein
the side surface is brought into contact with a first terminal base configured to connect an end portion of the windings to the electronic component electrically.

7. The rotating electrical machine according to claim 5, wherein
the first terminal base includes:
a bus bar configured to connect the end portion of the windings to the electronic component electrically; and
a molded resin member disposed around the bus bar; and
the side surface is brought into contact with a flat surface formed on the molded resin member.

8. The rotating electrical machine according to claim 6, wherein
the first terminal base includes:
a bus bar configured to connect the end portion of the windings to the electronic component electrically; and
a molded resin member disposed around the bus bar; and
the side surface is brought into contact with a flat surface formed on the molded resin member.

9. The rotating electrical machine according to claim 3, wherein
the opposite mounting surface is brought into contact with a second terminal base configured to connect the end portion of the windings to a power cable electrically.

10. The rotating electrical machine according to claim 4, wherein
the opposite mounting surface is brought into contact with a second terminal base configured to connect the end portion of the windings to a power cable electrically.

11. The rotating electrical machine according to claim 5, wherein
the opposite mounting surface is brought into contact with a second terminal base configured to connect the end portion of the windings to a power cable electrically.

12. The rotating electrical machine according to claim 6, wherein
the opposite mounting surface is brought into contact with a second terminal base configured to connect the end portion of the windings to a power cable electrically.

13. The rotating electrical machine according to claim 7, wherein
the opposite mounting surface is brought into contact with a second terminal base configured to connect the end portion of the windings to a power cable electrically.

14. The rotating electrical machine according to claim 8, wherein
the opposite mounting surface is brought into contact with a second terminal base configured to connect the end portion of the windings to a power cable electrically.

15. A rotating electrical machine comprising:
a rotating electrical machine main body portion including a stator and a rotor;
a winding switching unit configured to switch windings of the stator; and
mean for cooling an internal wiring including a wiring connecting the windings and the electronic component with a compact structure.
